(19) United States
(12) Patent Application Publication
(10) Pub. No.: US 2007/0078831 A1
(43) Pub. Date: Apr. 5, 2007

(54) Enterprise performance management tool

(75) Inventor: Anthony J. Relvas, Ladera Ranch, CA (US)

Correspondence Address: ACCENTURE CHICAGO 28164;BRINKS HOFER GILSON & LIONE, P O BOX 10395, CHICAGO, IL, 60610, US

(73) Assignee: Accenture Global Services GmbH

(21) Appl. No.: 11/366,168

(22) Filed: Mar. 1, 2006

Related U.S. Application Data
(60) Provisional application No. 60/722,611, filed on Sep. 30, 2005.

(51) Int. Cl. G06F 17/30

(52) U.S. Cl. 707/3

(57) ABSTRACT

An enterprise performance management system that includes a processor and a visual display electrically connected to the processor, wherein the processor prepares an advice screen to be shown on the visual display. The advice screen displays a first benchmark that represents a predetermined level of practice corresponding to an area of inquiry and a second benchmark that represents a second predetermined level of practice corresponding to the area of inquiry. The advice screen further displays a current state value that is representative of an entity's current level of practice regarding the area of inquiry and a weighting factor representative of the importance of the area of inquiry, wherein the first benchmark, the second benchmark, the current state and the weighting factor are displayed simultaneously so that advice on how to prioritize and accomplish achievement of a desired level of practice is rendered by such simultaneous display.

Applicant claims, under 35 U.S.C. §119(e), the benefit of priority of the filing date of Sep. 30, 20051999 of U.S. Provisional Patent Application No. 60/722,611, the entire contents of which are incorporated herein by reference.

### BACKGROUND OF THE INVENTION

1. Field of the Invention

The present invention relates to devices and processes that evaluate the strengths and weaknesses of an organization, such as a business.

2. Related Art

It is a well known for an organization, such as a business, to hire an outside consultant to perform an assessment of the current state of the organization's processes, technologies, and organization structure and to identify specific improvement opportunities. Such an assessment typically involves having the consultant visit the organization to interview key employees, to review existing organizational charts and documentation of processes, and conduct workshops. The assessment also can involve having the consultant observe the inner workings of the organization, such as the accounting process, the billing process, the shipping process and the power structure of the organization.

A critical element of the assessment is to interview various individuals of the organization in order to learn from them what they believe are the strengths and weaknesses of the organization. The interview can also be used to learn of various ideas from the individuals on how to improve the organization. Such interviews can be problematic. For example, the interviews need to be given at a convenient time for both the interviewer and the interviewee. That can be difficult based on the time of year, the business cycle of the organization and time intensive projects being launched at the time, for example.

A related problem is that the interviews usually result in the interviewee taking time off from his or her job in order to attend the interview. Obviously, this leads to lost productivity for the organization.

Besides the time issues, another problem of the process is the types of questions asked. The success of the interviews is highly dependent on the interviewer asking the right type of questions to the interviewee. An inexperienced interviewer may miss a key question to ask that may skew the results or lead to a follow up interview to ask the question. This obviously can be inefficient and costly. In addition, the interviewer may ask questions in a haphazard manner so that it is hard to assess the answers as a whole.

### SUMMARY OF THE INVENTION

One aspect of the present invention regards an enterprise performance management system that includes a processor and a visual display electrically connected to the processor, wherein the processor prepares an advice screen to be shown on the visual display. The advice screen displays a first benchmark that represents a predetermined level of practice corresponding to an area of inquiry and a second benchmark that represents a second predetermined level of practice corresponding to the area of inquiry. The advice screen further displays a current state value that is representative of an entity's current level of practice regarding the area of inquiry and a weighting factor representative of the importance of the area of inquiry, wherein the first benchmark, the second benchmark, the current state and the weighting factor are displayed simultaneously so that advice on how to prioritize and accomplish achievement of a desired level of practice is rendered by such simultaneous display.

A second aspect of the present invention regards an enterprise performance management system that includes a processor and a visual display electrically connected to the processor, wherein the processor prepares an advice screen to be shown on the visual display. The advice screen displaying a first state value that is representative of an entity's level of practice regarding an area of inquiry during a first time frame and a second state value that is representative of an entity's level of practice regarding the area of inquiry at a second time frame different than the first time frame. The first state value and the second state value are displayed simultaneously so that advice on how to achieve a desired level of practice is rendered by such simultaneous display.

A third aspect of the present invention regards a method of providing advice on how to achieve a desired level of practice that includes having a client provide an answer regarding a financial related question regarding an area of interest and determining a current state level of the client based on the answer. The method further includes preparing and displaying an advice report by simultaneously displaying the current state level, a first benchmark that represents a predetermined level of practice corresponding to the area of interest and a second benchmark that represents a second predetermined level of practice corresponding to the area of interest, wherein advice on how to achieve a desired level of practice is rendered by such simultaneous displaying. The method further includes providing advice to the client based on the advice report so that the client achieves the desired level of practice.

### BRIEF DESCRIPTION OF THE DRAWINGS

FIG. 1 schematically shows an embodiment of an enterprise performance management evaluation process in accordance with the present invention;

FIGS. 2A-D show examples of externally available information regarding a client that can be used to perform a high level analysis for the enterprise performance management evaluation process of FIG. 1;

FIG. 3 shows an embodiment of an enterprise performance management diagnostic matrix in accordance with the present invention;

FIG. 4 schematically shows an embodiment of an Enterprise Performance Management (EPM) Framework in accordance with the present invention;

FIG. 5 schematically shows an embodiment of an enterprise performance management system in accordance with the present invention;

FIG. 6 shows an embodiment of a “Demographics Section” screen to be used by the enterprise performance management system of FIG. 5;

FIG. 7 shows an embodiment of an Enterprise Performance Management Navigation screen to be used by the enterprise performance management system of FIG. 5;

FIG. 8 shows an embodiment of a status screen to be used by the enterprise performance management system of FIG. 5;

FIG. 9 shows an embodiment of an instructions screen to be used by the enterprise performance management system of FIG. 5;

FIGS. 10A-G show embodiments of survey screens to be used by the enterprise performance management system of FIG. 5;

FIG. 11 shows an embodiment of a survey summary screen to be used by the enterprise performance management system of FIG. 5;

FIG. 12 show an embodiment of a status screen to be used by the enterprise performance management system of FIG. 5;

FIG. 13 shows an embodiment of a status screen to be used by the enterprise performance management system of FIG. 5;

FIGS. 14A-B show an embodiment of a consolidation table to be used by the enterprise performance management system of FIG. 5;

FIG. 15 shows a sample of the consolidation table of FIGS. 14A-B;

FIG. 16 shows an embodiment of a consolidation screen to be used by the enterprise performance management system of FIG. 5;

FIGS. 17A-G show embodiments of charts to be used by the enterprise performance management system of FIG. 5;

FIG. 18 shows an embodiment of a management process summary chart to be used by the enterprise performance management system of FIG. 5; and

FIG. 19 shows an embodiment of an enablers process summary chart to be used by the enterprise performance management system of FIG. 5.

### DETAILED DESCRIPTION OF THE DRAWINGS AND THE PRESENTLY PREFERRED EMBODIMENTS

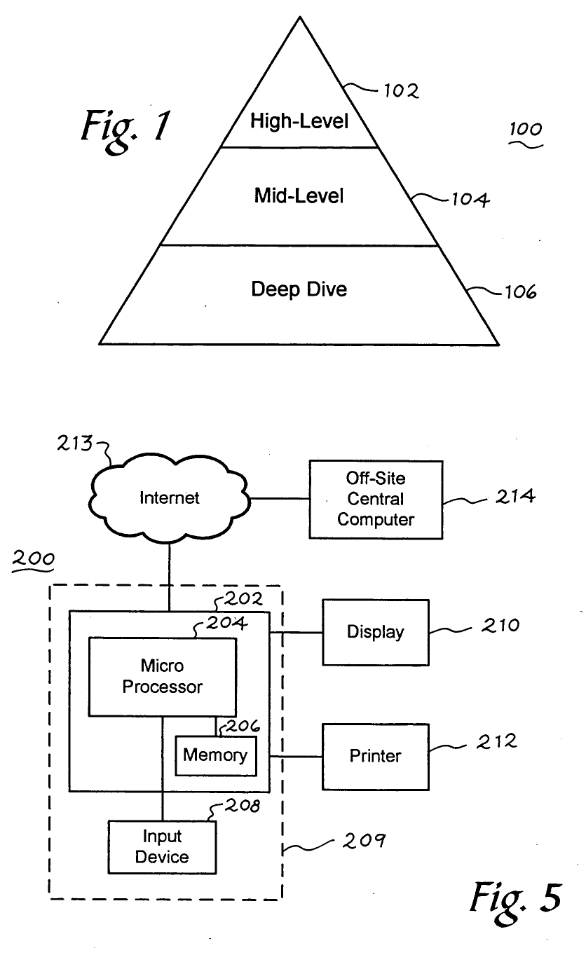

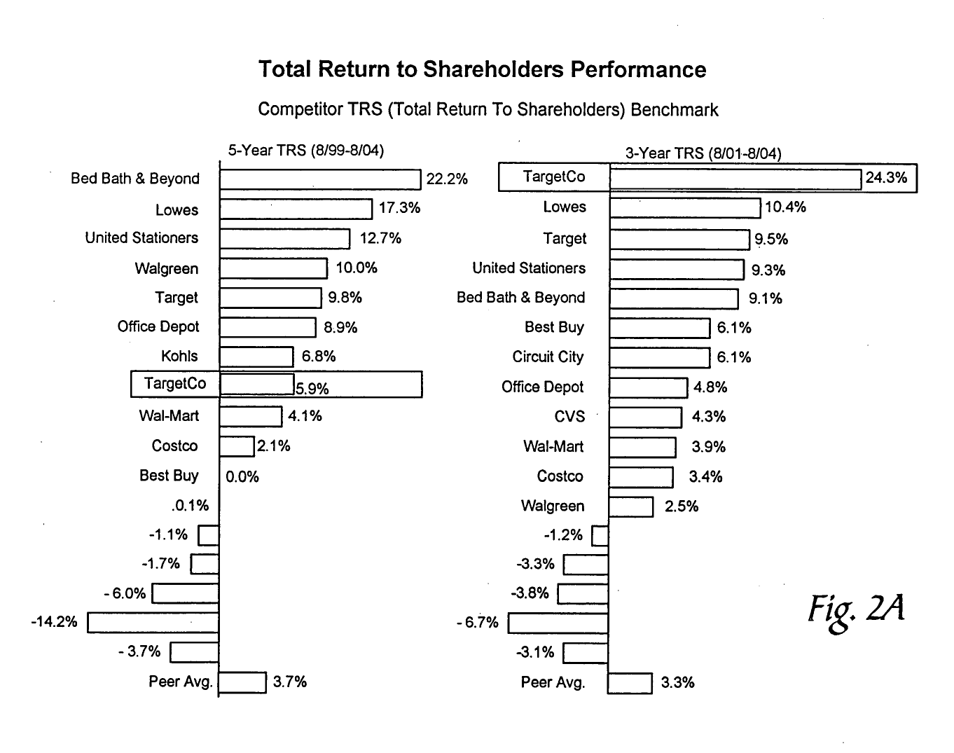

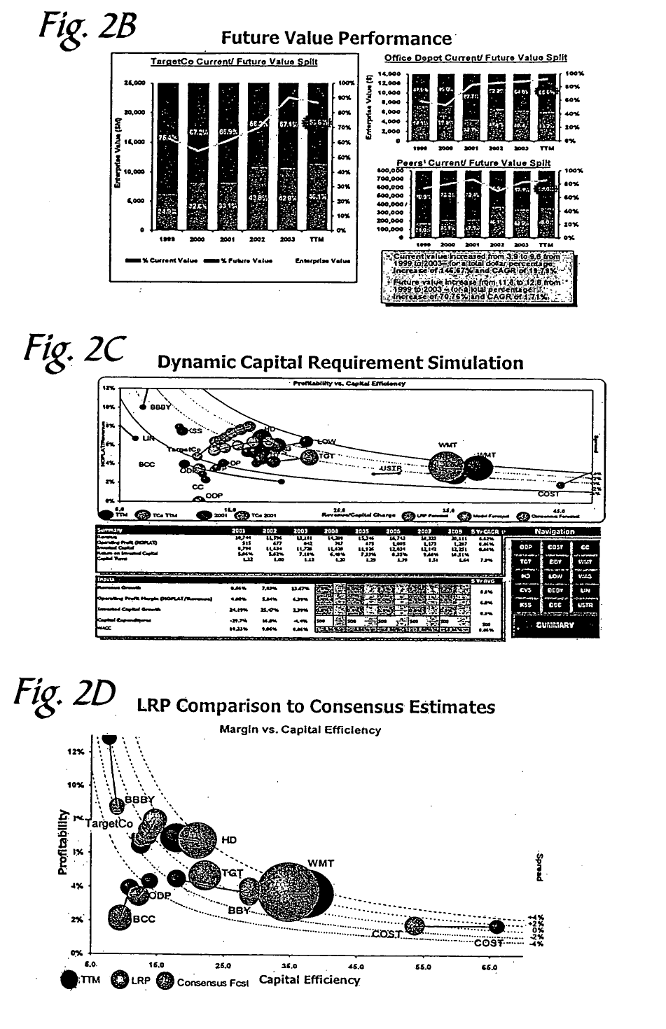

As schematically shown in FIG. 1, the enterprise performance management evaluation process 100 according to the present invention has three levels of inquiry are performed for the client, such as a business. At the high-level inquiry 102, a financial and qualitative analysis is performed. Such analysis involves analyzing externally available information regarding the client. Examples of externally available information are SEC filings and press releases regarding the client. As shown in FIGS. 2A-D, such externally available information may include objective information such as: 1) Total Return to Shareholders Performance (FIG. 2A) and 2) Future Value Performance (FIG. 2B). The externally available information may be subjective in nature, such as the quality of information released by a company or the timing of when information is released via a press release. The externally available information can also be processed to provide models/simulations/ estimates, such as 1) Dynamic Capital Requirement Simulation (FIG. 2C) and 2) Long Range Plan (LRP) Comparison to Consensus Estimates (FIG. 2D).

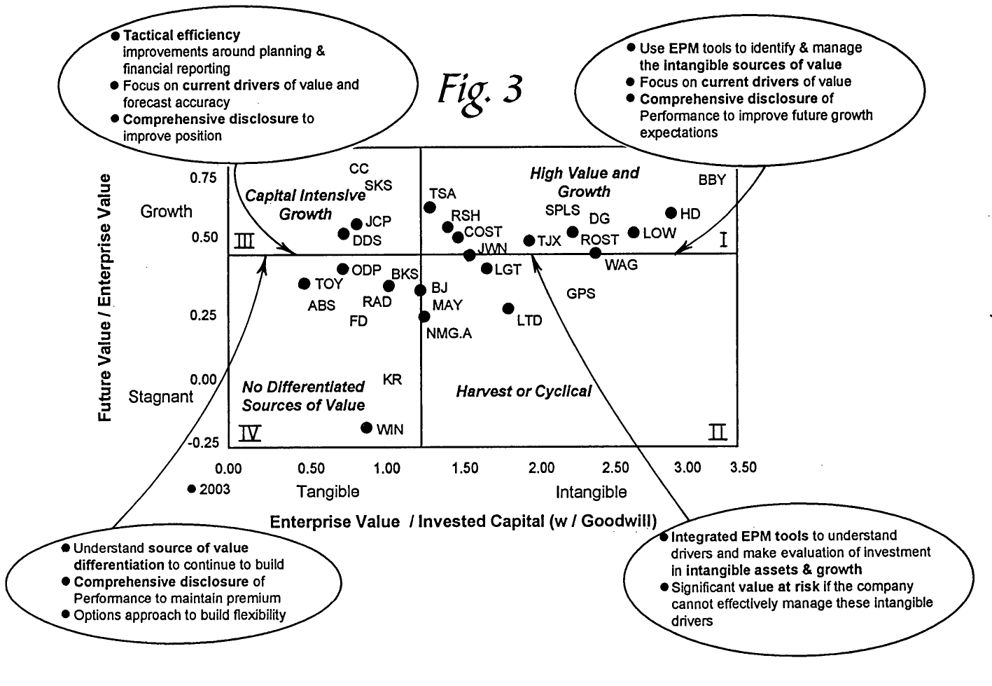

As part of the high-level inquiry 102, externally available data regarding other companies and industries can be gathered and compared with corresponding externally available data of the client. An example of a possible comparison is a 2×2 enterprise performance management diagnostic matrix. An example of such a matrix is shown in FIG. 3, wherein externally available data of a group of retailing companies is displayed. As shown in FIG. 3, the x-axis of the matrix tracks the ratio enterprise value to invested capital (with good will). This ratio is a measure of the amount of value a company has accumulated as a function of the amount of capital it has invested. Companies having a ratio of less than approximately 1.25 have the relative characteristics of generating value based on the amount of invested capital rather than generating excess value exceeding invested capital. Companies having a ratio of more than approximately 1.25 have the relative characteristic of relying on a great amount of their value to intangible factors, such as customer relationships and intellectual property.

As shown in FIG. 3, the y-axis of the matrix tracks the ratio future value to enterprise value. The ratio measures how much growth is expected as a function of a company's overall value. Companies having a ratio of less than approximately 0.5 have the relative characteristic that their future value is less than current value. Companies having a ratio of more than approximately 0.5 have the relative characteristic that their total future value is greater than current value

The 2×2 matrix can be thought of as defining four quadrants: I, II, III and IV. Quadrant I contains companies that have high growth and have values that are driven by intangible factors. Examples of quadrant I companies would be Walmart, Best Buy and Home Depot. Such companies need integrated enterprise performance management tools to understand the drivers, both tangible and intangible, of their source of market valuation differentiation to continue to develop growth. The company's high value is at risk if the company does not understand and cannot effectively manage its own intangible drivers of its value.

Quadrant II companies have lower levels of growth. While they have intangible factors that drive their overall value, their overall value is concentrated in current profitability and current expectations. Such companies should focus on tactical efficiency improvements around planning & financial reporting, For these types of companies it is again important to use enterprise performance management tools to identify and manage intangible sources of value and focus in particular on current time drivers of value and forecast accuracy. Furthermore, it is important to provide a comprehensive disclosure of performance to the investment community in order to improve future growth expectations.

Quadrant III companies have high growth while their overall value is mostly concentrated on their values reflected in their financial books or balance sheets. For such companies, there is a need to understand the sources of value differentiation so that the client can continue to build its overall value based on the more important sources of value. Such companies need to provide comprehensive external disclosure of their performance in order to maintain their premium growth expectation. In addition, quadrant III companies should implement an options approach to investment so that they have the flexibility to move to the right of the 2×2 matrix and into quadrant I and thus rely more on intangibles for determining their overall value.

Quadrant IV companies have low growth expectations and their overall value is mostly concentrated on tangible assets reflected in their balance sheet. For such companies, it is important for them to be able to improve their tactical efficiency around their planning and financial reporting. Such companies need to focus on their current drivers of value and forecast accuracy. It is also important for those companies to provide a comprehensive external disclosure of their performance so as to improve their overall value.

Besides the high-level inquiry 102, a mid-level inquiry 104 is performed so as to examine performance of the client at a more granular level. In this level of inquiry, personnel of the client, such as a management team, are interviewed regarding a number of management processes currently performed by the client. Such interviews can be conducted in a one-on-one manner or in a workshop setting. Each answer is then compared with a best practice standard so as to identify areas where the client is strong and weak. Based on the comparison and the gaps between present practice and the best practice standard, recommendations can be made to close such gaps.

Besides looking at external information (high level 102) and comparison data (mid-level 104), the present invention also entails performing a deep-level inquiry 106 of inquiry that involves performing detailed diagnostics on one or more particular issues that are identified by the client itself in a survey to be of particular importance to the client. Such particular issues can include specific challenges and questions the client is trying to address, such as human performance, business intelligence tools and supply chain management.

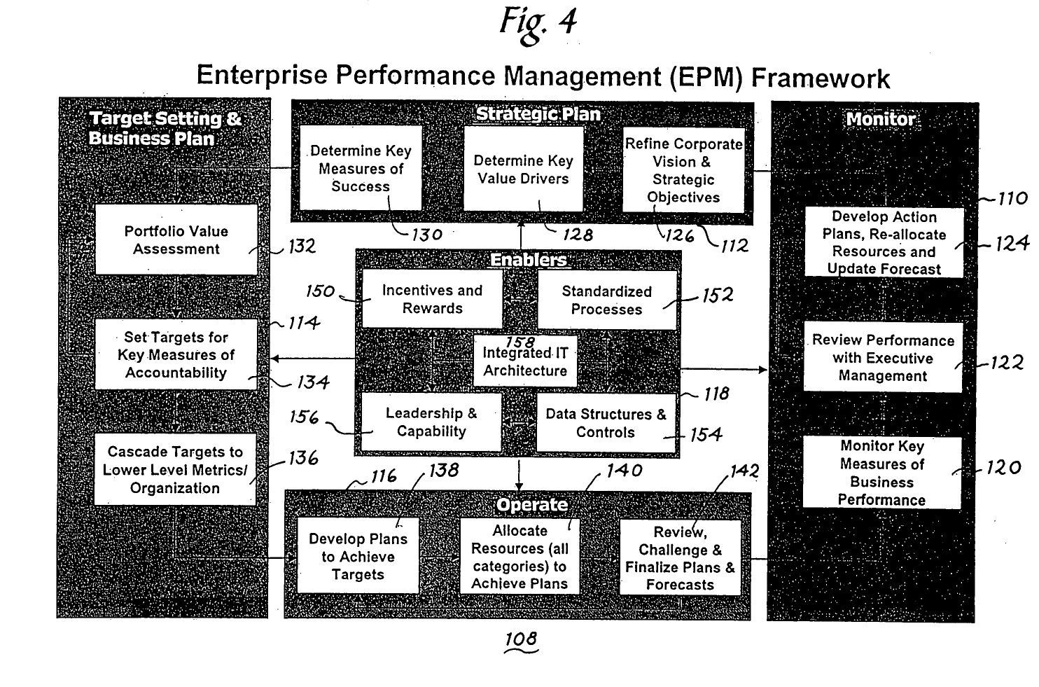

FIG. 4 schematically shows an Enterprise Performance Management (EPM) Framework 108 that defines an environment in which the present invention is implemented. The EPM Framework includes five main components: 1) Monitor component 110, 2) Strategic Plan component 112, 3) Target Setting & Business Plan component 114, 4) Operate component 116 and 5) Enablers component 118. In operation, EPM Framework 108 involves monitoring the client's performance via Monitor component 110 by performing one or more of the steps of monitoring key measures of business performance 120, reviewing performance with client personnel, such as executive management, 122, and developing action plans, reallocating resources and updating forecasts 124.

Based on the actions taken by the Monitor component 110, the Strategic Plan component 112 is implemented. In particular, the Strategic Plan component 112 performs one or more of the following tasks: 1) refining corporate vision and strategic objectives 126, 2) determining key value drivers 128 and 3) determining key measures of success 130. Such drivers and measures of success can involve tangible and intangible components as well as financial and non-financial components.

Armed with the goals determined by the Strategic Plan component 112, the Target Setting & Business Plan component 114 is able to establish a business/management plan for the client. The Target Setting & Business Plan component performs one or more of the following tasks: 1) assessing portfolio value of the client 132 by analyzing the financial value performance of each operating group or business unit within a company, 2) setting targets for key measure of accountability 134 by understanding the key drivers of a business unit, how these key drivers are measured with key performance indicators or metrics, and setting appropriate targets for each measure (i.e., sales must be $900 this year versus $850 for last year) and 3) cascading targets to lower level metrics/organization 136 by breaking down the overall company's sales target into each business unit and ultimately to a sales team and to a sales person (i.e., for sales target of $900 for this year, $450 of this amount will be the sales target for Business Unit A and within Business Unit A, sales team 10 has a sales target of $100, etc.).

Once the business plan is substantially established per Target Setting & Business Plan component 114, the business plan is finalized by the Operate component 116. Such finalization is accomplished by performing one or more of the following processes based on the final output from the Target Setting & Business Plan component 114: 1) develop plans to achieve targets 138, 2) allocate resources (all categories) to achieve plans 140 and 3) review, challenge & finalize plans & forecasts 142.

Now that the business plan has been finalized, it is implemented by the client. In order to determine the effectiveness of the business plan, it needs to be monitored. The business plan generated by the Operate component 116 is fed to the Monitor component 110 wherein the cycle described previously with respect to the Strategic Plan component 114, the Target Setting & Business Plan component 116, the Operate component 118 and the Monitor component 120 is then repeated.

As shown in FIG. 4, the Strategic Plan component 112, the Target Setting & Business Plan component 114, the Operate component 116 and the Monitor component 110 and their various functional elements are implemented by the Enabling component 118 that includes: 1) incentives and rewards 150, 2) standardized processes 152, 3) data structures & controls 154, 4) leadership & capability and 5) integrated IT architecture 158.

An embodiment of the present invention is shown in FIG. 5. In particular, FIG. 5 schematically shows an enterprise performance management system 200 that includes an enterprise performance management processor 202 that includes a microprocessor 204 electrically connected to a memory 206. The memory 206 stores an enterprise performance management program that includes a database, the contents of which will be discussed below. The microprocessor 204 runs the enterprise performance management program, which preferably is in the Microsoft Excel format. (or another software application) The enterprise performance management program is directed to performing the mid-level inquiry 104 mentioned previously with respect to FIG. 1. Programs involving the high-level inquiry 102 and the deep-level inquiry 106 can also be stored in memory 206 and performed by microprocessor 204.

Data is input indirectly into the microprocessor 204 via an input device 208. Examples of possible input devices 208 are a keyboard, a microphone, a touch screen or a mouse that are part of computer hardware system, such as a laptop computer 209. A display 210 and a printer 212 can be electrically connected to or form part of the computer hardware system.

As shown in FIG. 5, the laptop computer 209 may be connected to an off-site computer 214 via the Internet 213. In such a scenario, the computer 214 receives data from the laptop computer 209, processes the received data and sends the processed data back to the microprocessor 204 and memory 206. Thus, the data can be processed at a location different than the location of the laptop computer 209. This allows for flexibility in conducting the evaluation process. Of course, it is possible to have the microprocessor 204 of the laptop computer 209 to be able to process the data by itself so that data does not need to be sent to the off-site computer 214.

In general, once data is input into the microprocessor 204, the enterprise performance management program takes the data and places the data in the database in memory 206. The contents of the database can be observed via the visual display 210 or can be printed out via the printer 212.

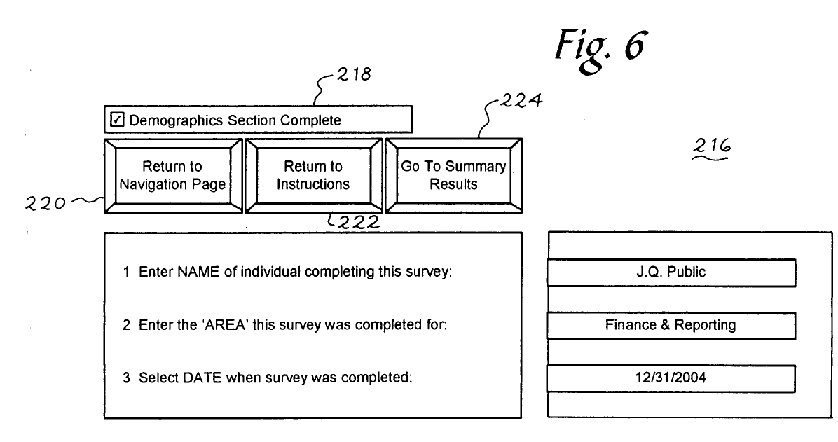

With the above mentioned structure of the enterprise performance management system 200 described, operation of the enterprise performance management system 200 when performing the mid-level inquiry 104 will be described hereinafter. As shown in FIG. 6, once enterprise performance management system 200 is activated a “Demographics Section” screen 216 pops up on visual display 210. The screen 216 sets forth three items to be filled out by the user: 1) the name of the client participating in the survey, 2) the area that the survey was completed for and 3) the date when the survey was completed. Once the three items are filled out, the “Demographics Section Complete” box 218 is checked as shown in FIG. 6. At this stage, the user can enable either the “Return to Navigation Page” button 220, the “Return to Instructions” button 222 or the “Go to Summary Results” button 224. The results of enabling either of the buttons is discussed hereinafter.

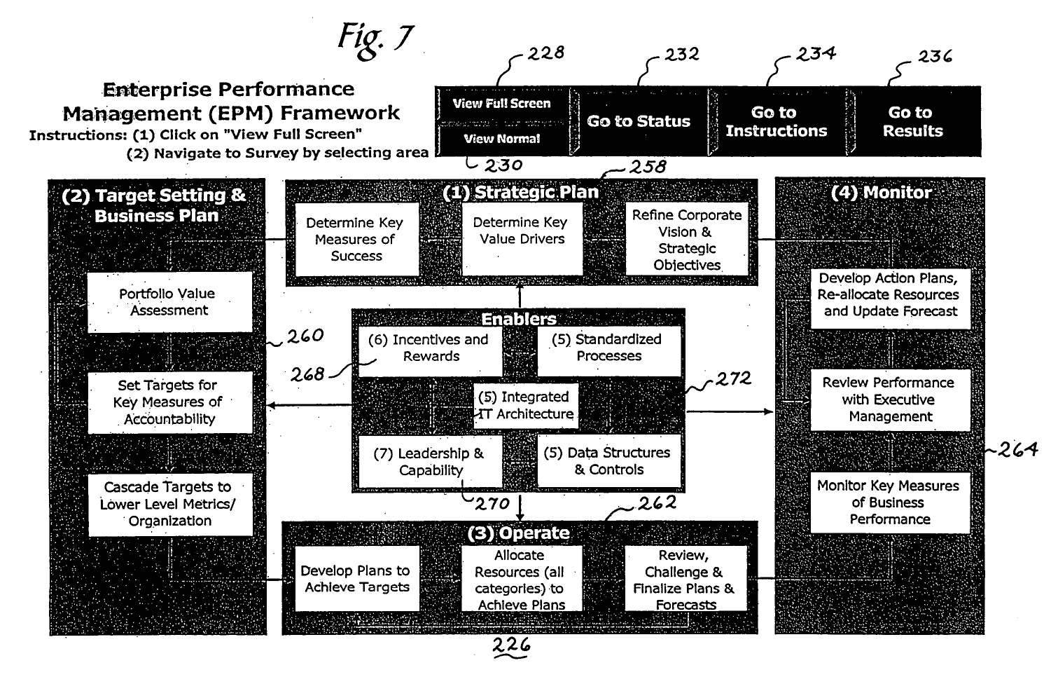

In the case where the “Return to Navigation Page” button 220 is enabled, an Enterprise Performance Management Navigation screen 226 (FIG. 7) is displayed on visual display 210. The screen 226 shows in part the Enterprise Performance Management Framework shown in FIG. 4. In addition, the screen 226 includes several input buttons: 1) the “View Full Screen” button 228, 2) the “View Normal” button 230, 3) the “Go to Status” button 232, 4) the “Go to Instructions” button 234 and 5) the “Go to Results” button 236. The input buttons are enabled by the user, via input device 208, in order to navigate the various functions shown on the screen 226. For example, enabling the “View Full Screen” button 224 results in the input buttons 224, 226, 228, 230 and 232 being hidden and the Enterprise Performance Management Framework remaining. Enabling the “View Normal” button 226 results in the screen shown in FIG. 4 being shown.

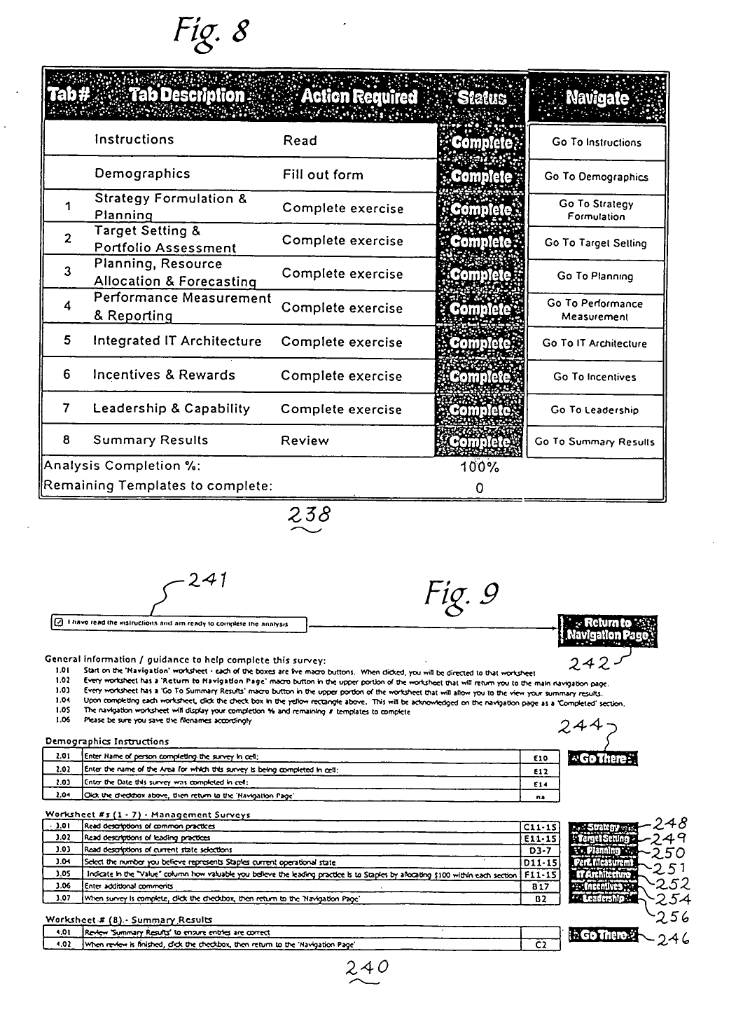

Enabling the “Go to Status” button 232 results in the status screen 238 of FIG. 8 being displayed on the visual display 210. The screen 238 provides the status of various tasks to be performed by the user and client during the mid-level inquiry 104. For example, the “Tab Description” column lists 1) the “Instructions” and “Demographics” screens to be read and filled out by the user, 2) the seven surveys to be performed by the client and listed under Tabs 1-7 and 3) a summary of the results of the seven surveys of Tabs 1-7 to be reviewed by the user. The “Action Required” column lists the actions to be performed for each of the tasks listed in the “Tab Description” column. The “Status” column displays whether or not the tasks are completed. The “Navigate” column provides access buttons for each task so that by clicking on the button, the screen changes to the screen/task corresponding to the button clicked. Note that the screen 238 also lists on the bottom the percentage of the tasks that have the status of “complete” and the number of tasks that need to be performed.

Enabling the “Go to Instructions” button 234 of the Enterprise Performance Management Navigation screen 226 results in the instructions screen 240 of FIG. 9 being displayed on the visual display 210. The screen 240 provides instructions for completing various tasks associated with the enterprise performance management system 200. For example, the screen 240 includes general information and guidance on how to complete the survey to be given to the client.

In addition, the screen 240 provides instructions on inputting data for the “Demographics Section” screen 214 and seven management surveys that will be discussed later. The screen 240 also reminds the user to review the Summary Results consolidated survey results and various charts that will discussed later. Once all of the instructions have been reviewed by the user, the user clicks on the completion box 241 as shown in FIG. 9. Clicking on box 241 results in the “Instructions” task to have a status of “Complete” registered on status screen 238.

Note that the instructions screen 240 includes a number of buttons that allow the user to: 1) return to the navigation screen 226 (via button 242), 2) go to the demographics screen 214 via button 244, 3) go to the summary of results (to be discussed later) via button 246 and 4) go to the strategy, target, planning, performance measurement, IT architecture, incentives and leadership management surveys/screens (to be discussed later) via buttons 248, 249, 250, 251, 252, 254 and 256, respectively.

Once the user has completed the instructions screen 240, he or she is prepared to conduct one or more surveys with certain personnel affiliated with the client, such as the management team of the client. From the instructions screen 240, the user clicks on the “Return to Navigation Page” button 242 which results on the Navigation screen 226 of FIG. 7 appearing on the visual display 210. Next, the “View Full Screen” button 228 is activated resulting in a screen like that shown in FIG. 4. From this screen, seven survey or advice screens can be accessed: 1) Strategy Formulation & Planning, 2) Target Setting & Portfolio Assessment, 3) Planning, Resource Allocation & Forecasting, 4) Performance Measurement & Reporting, 5) Integrated IT Architecture, 6) Incentives & Rewards and 7) Leadership & Capability. The Strategy Formulation & Planning survey is accessed by clicking on the Strategic Plan box 258. The Target Setting & Portfolio Assessment survey is accessed by clicking on the Target Setting & Business Plan box 260. The Planning, Resource Allocation & Forecasting survey is accessed by clicking on the Operate box 262. The Performance Measurement & Reporting survey is accessed by clicking on the Monitor box 264. The Integrated IT Architecture, Incentives & Rewards and Leadership & Capability surveys are accessed by clicking on their corresponding boxes 266, 268 and 270, respectively, located in the Enablers box 272.

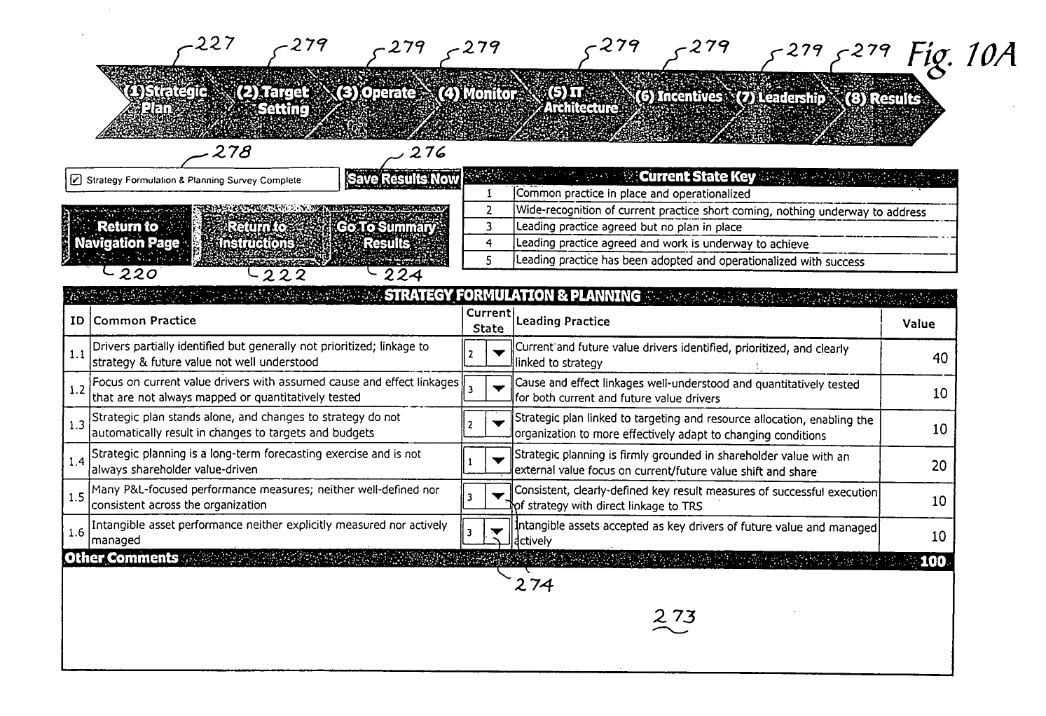

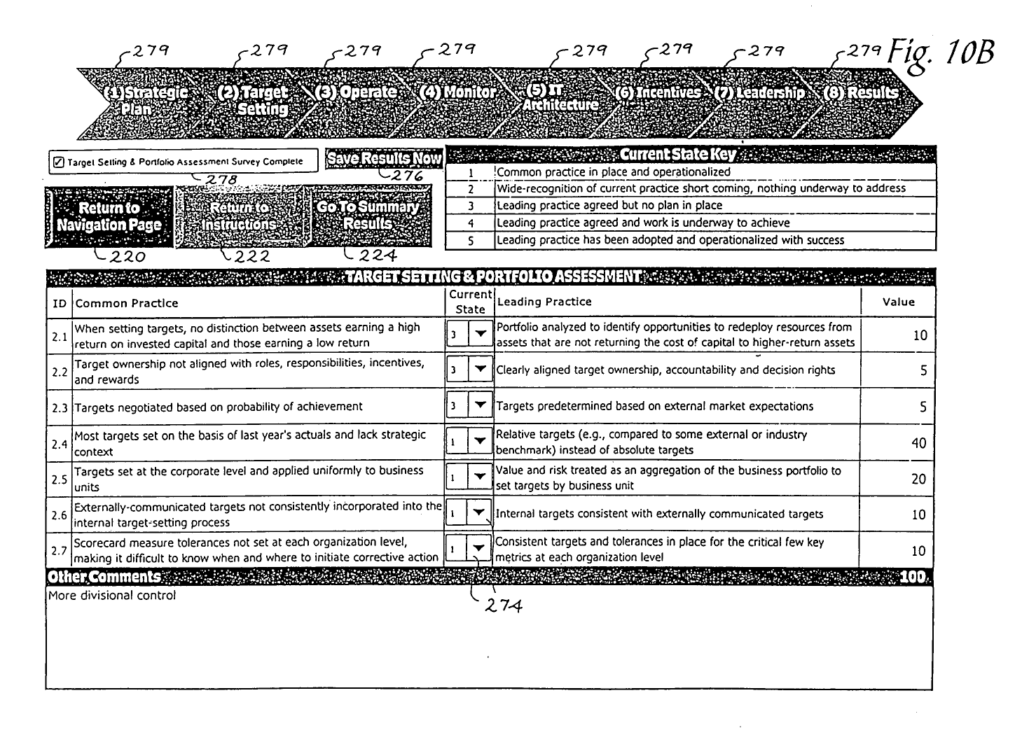

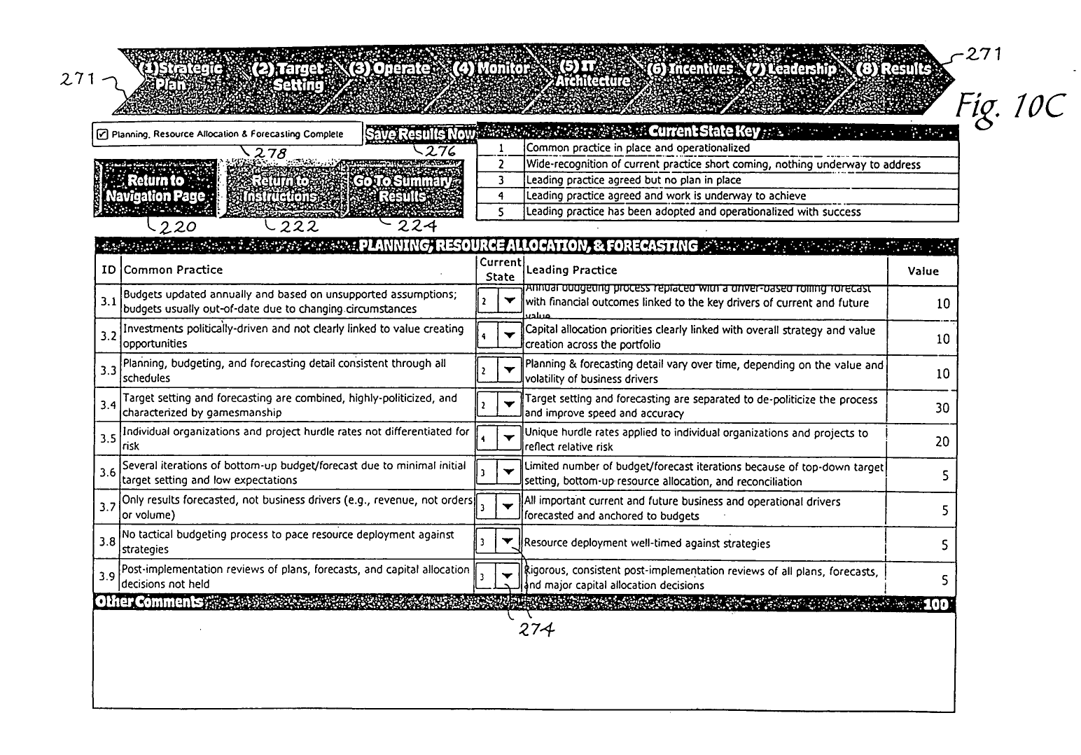

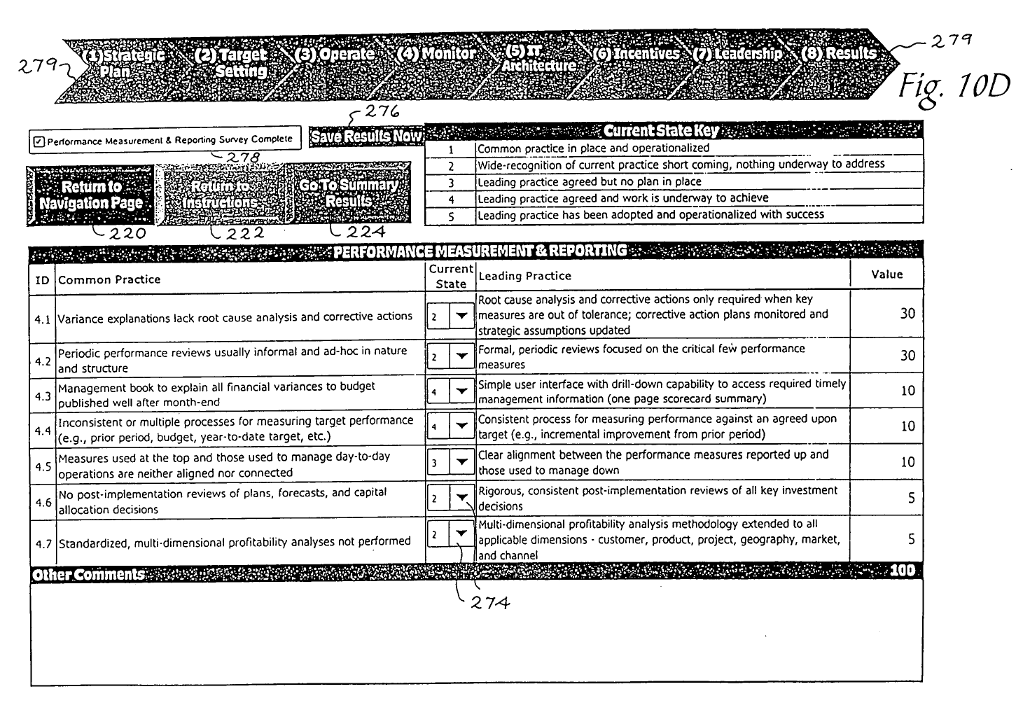

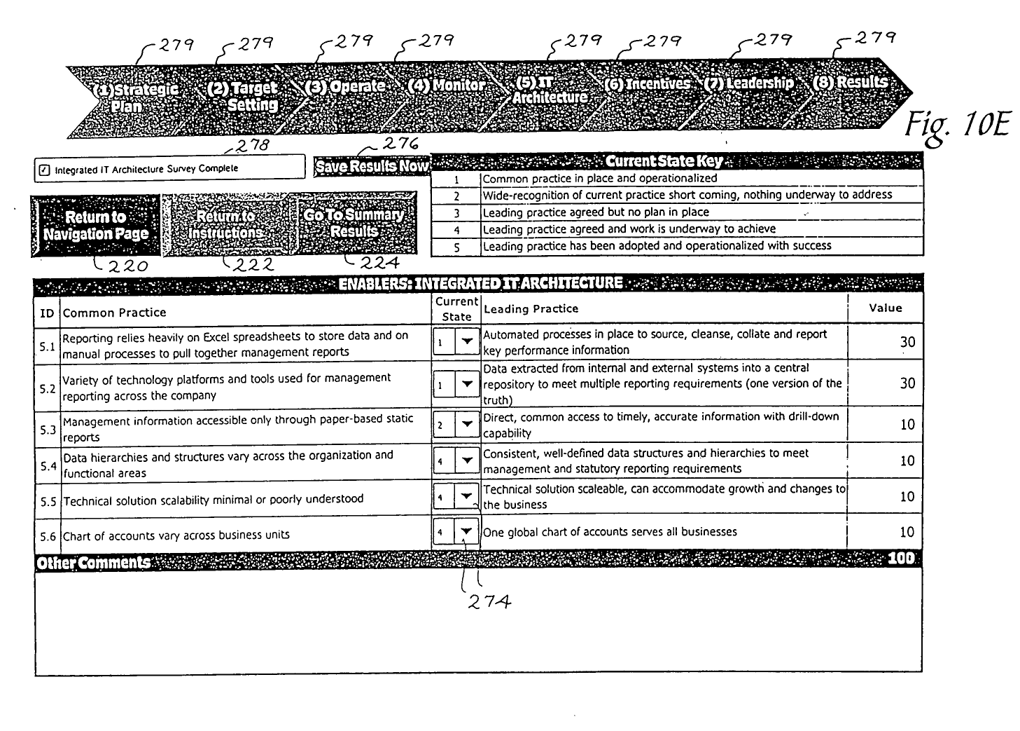

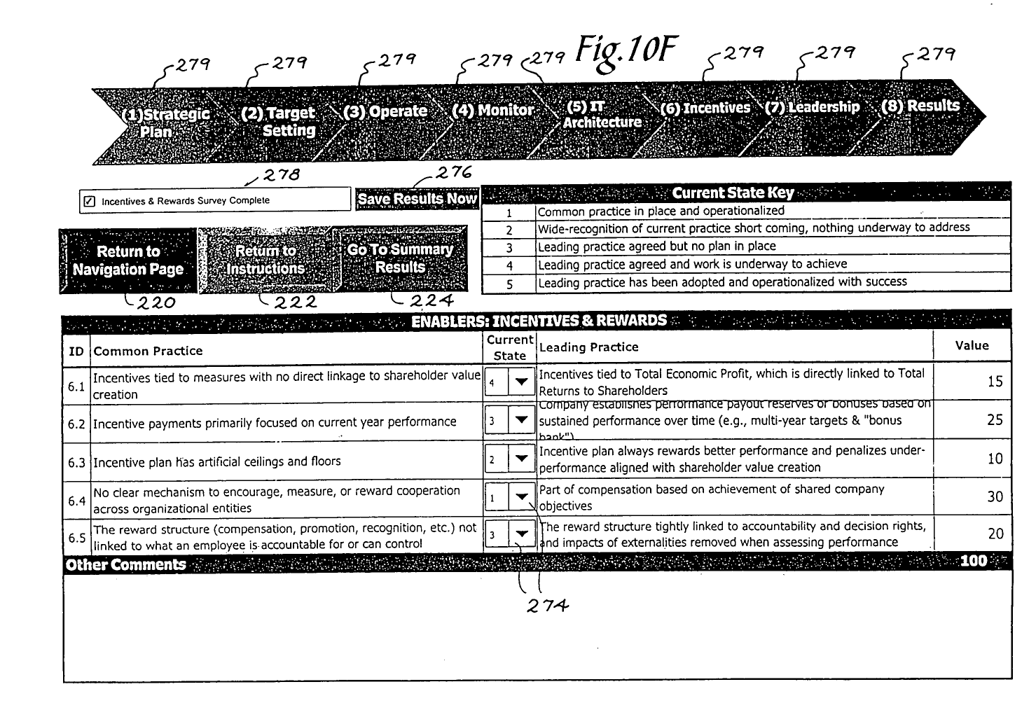

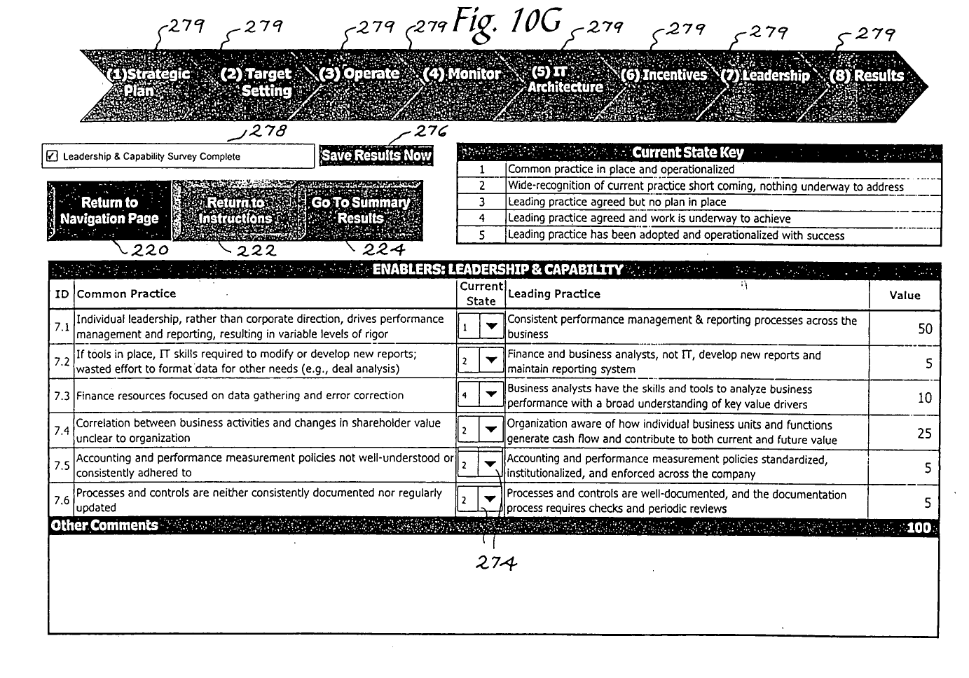

For illustrative purposes, suppose the Strategic Plan box 258 is clicked. The Strategy Formulation & Planning survey or advice screen 273 of FIG. 10A is displayed on visual display 210. In this example, the survey includes six areas of inquiry. In one column a list of common practices in the industry for the areas of inquiry is presented and in another column corresponding leading practices are listed. The common practices and leading practices listed are based on surveys that have been performed by Accenture LLP in the past for previous clients. In operation, the user asks the client diagnostic questions regarding each of the six areas of inquiry. Such diagnostic questions may be stored in memory 206 and accessible via display 210. The user tries to determine from the client's answers if the client's current practices are nearest the common practice or the leading practice. Such determination is embodied by assigning a state number ranging from 1 to 5 that is representative of the state of the client in the area of inquiry. A state number of 1 represents that the client is practicing the common practice and it has been operationalized, wherein the common practice is the minimum level of practice at which a company can perform. A state number of 2 represents that it is widely recognized that the client's current practice while being at least at the common practice level is wanting and no steps are currently being undertaken to correct such shortcoming. A state number of 3 represents that the client is performing at least the common practice and agrees to practice the leading practice, but no plan is currently in place to implement the leading practice. A state number of 4 represents that the client is performing at least the common practice and agrees to practice the leading practice and work is currently underway to implement the leading practice. A state number of 5 represents that the client has adopted the leading practice and it has been operating with success. Drop down menus 274 with values of 1 through 5 are used for rating the areas of inquiry.

Besides determining the state for each area of inquiry, the user establishes a weighting for each area of inquiry in the “Value” column. The weighting reflects how important the user believes each area of inquiry is relative to one another. The weightings should total 100. If they do not, then alerts will appear on the screen informing the user whether the total is either above or below 100.

At any time during the survey, comments by the client or the user can be typed in the “Other Comments” section. Also, the results can be saved in memory 206 by clicking on the “Save Results Now” button 276. Once all of the areas of inquiry shown on screen 273 are evaluated and all comments are entered, the user clicks on the completion box 278 to store the current state and weighted values in memory 206. Clicking on box 278 also results in the “Strategy Formulation & Planning” task to have a status of “Complete” registered on status screen 238.

At this stage, the user can activate either the “Return to Navigation Page” button 220, the “Return to Instructions” button 222 or the “Go to Summary Results” button 224 of screen 273. Activating the button 220 returns the user to screen 226 of FIG. 7 wherein the user can then select one of the six remaining surveys to be completed in the manner described previously. Access to a particular survey can also be obtained by clicking on a button 279 of screen 273 that corresponds to the desired survey. The advice screens for the six surveys are shown in FIGS. 10B-10G. The format of the six surveys and their corresponding screens are similar to the survey of FIG. 10A and so the six surveys are performed in a manner similar to that previously described with respect to the survey corresponding to the screen 273 of FIG. 10A.

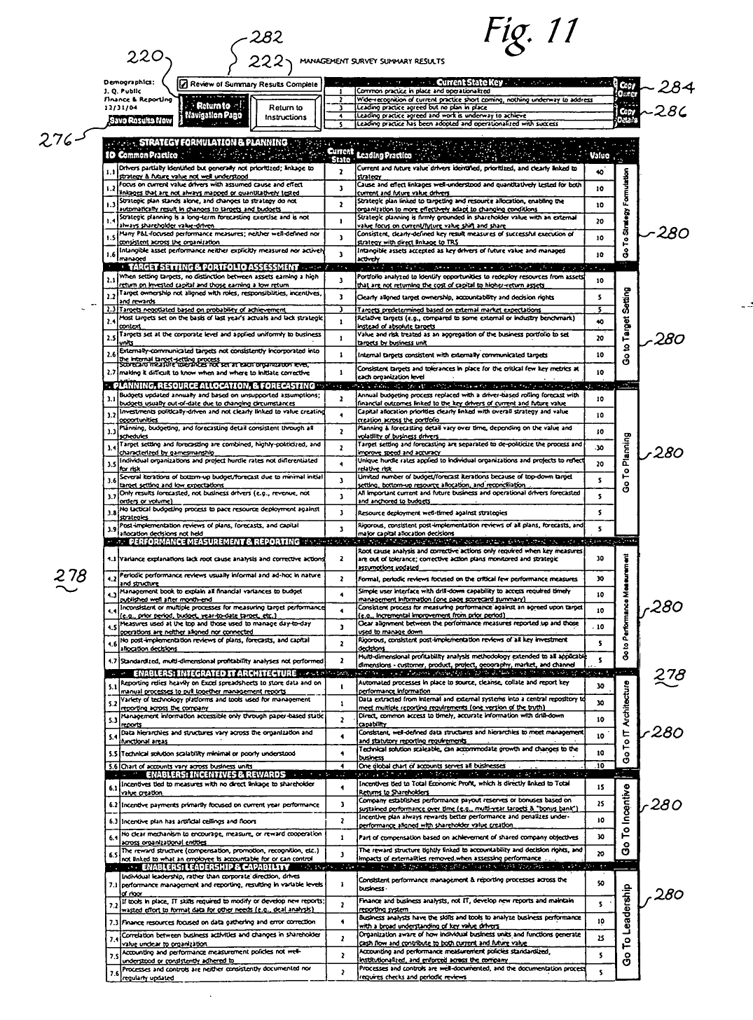

At any time during the survey process, the user can click on the “Go to Summary Results” button 224 (clicking on buttons 236 and 246 work in a similar manner). Activation of button 224 results in an advice screen 278 being displayed on visual display 210. As shown in FIG. 11, the advice screen 278 shows the results for each of the seven surveys. For each survey is a corresponding button 280 to allow the user to return to the survey to confirm or alter the results of the survey.

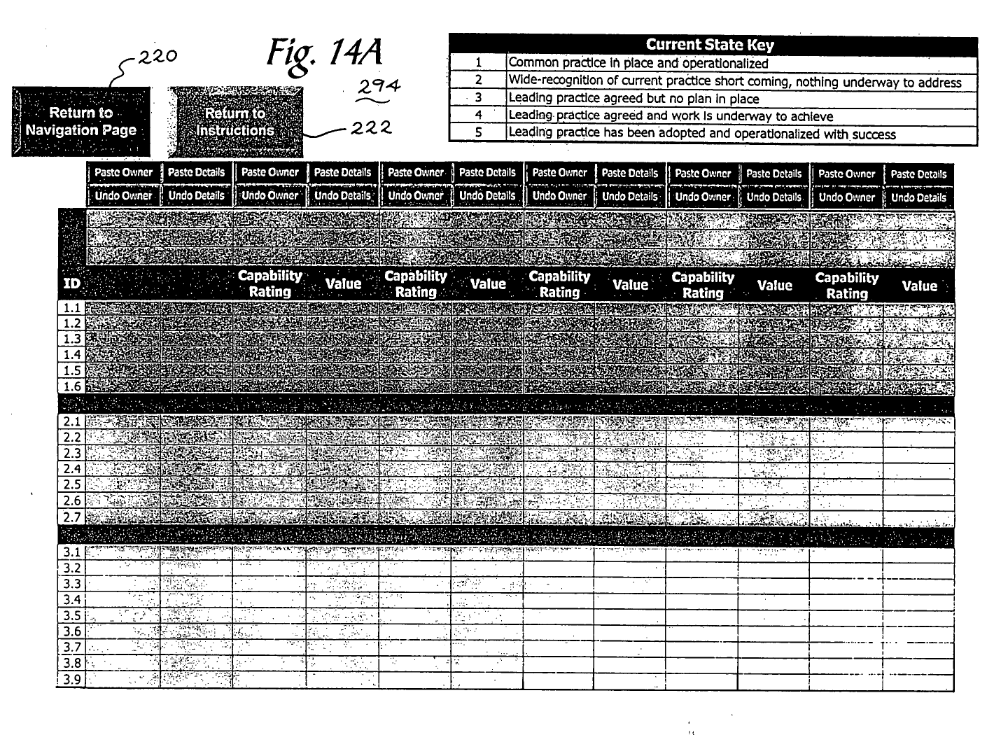

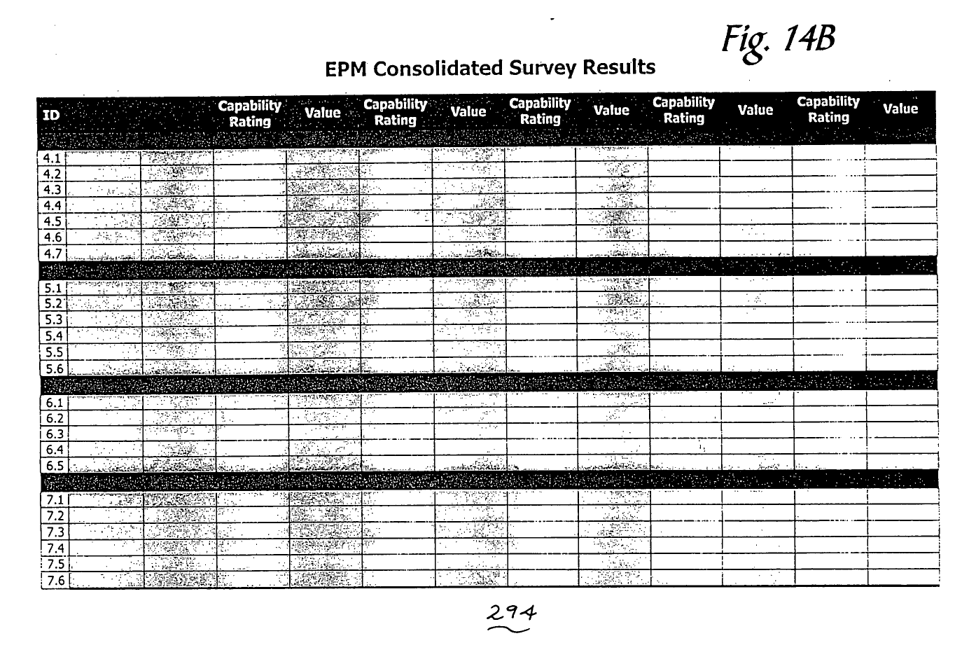

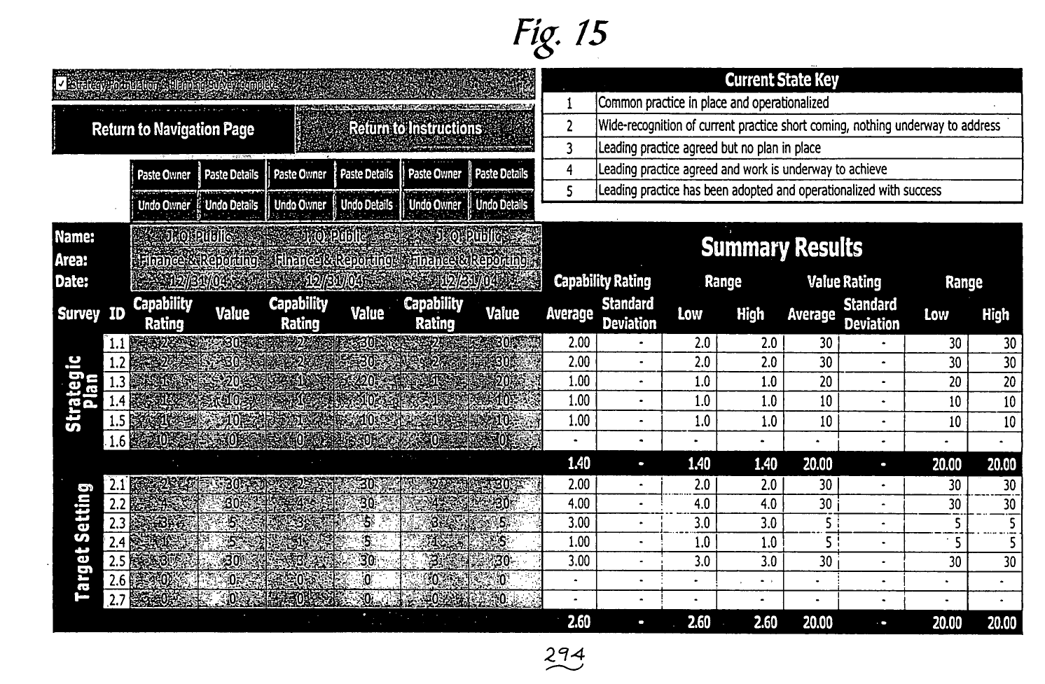

Once the results of all of the survey summaries are confirmed to be correct, the user clicks on the save results box 276 and the completion box 282 so that the results are stored in memory 206. A copy of the summary of results can be sent to the client by clicking on box 284 and a general copy of the details can be sent to the screen shown in FIG. 14A. Clicking on box 282 results in the “Summary Results” task to have a status of “Complete” registered on status screen 238.

What has been previously described is a way of obtaining enterprise performance management mid-level data via surveys at a particular point in time. It is beneficial to repeat the survey process for the client at different points in time, such as in six month or one year increments. This results in data for multiple surveys being accumulated. In such a case, a consolidation tool can be implemented as will be described below.

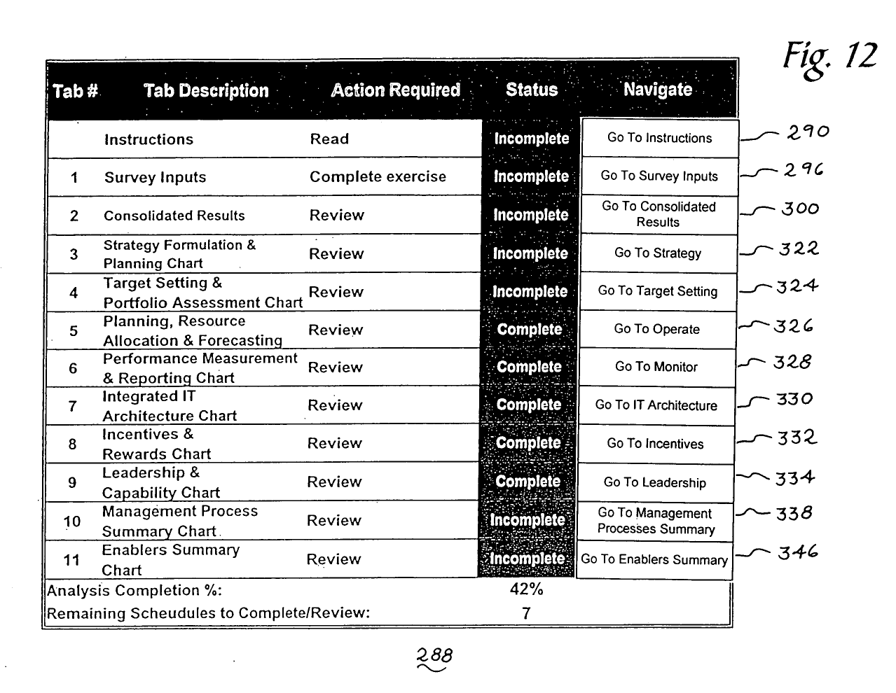

Activation of the consolidation tool results in the status screen 288 of FIG. 12 being displayed on the visual display 210. The screen 288 provides the status of various tasks and charts monitored and generated by the consolidation tool. For example, the “Tab Description” column lists the “Instructions” screen, “Survey Inputs” screen, “Consolidated Results” screen, charts for the consolidated results for the seven surveys to be performed by the client, a “Management Process Summary Chart” and an “Enablers Summary Chart.” The “Action Required” column lists the actions to be performed for each of the tasks and charts listed in the “Tab Description” column. The “Status” column displays whether the tasks/charts are completed or not completed. The “Navigate” column provides access buttons for each task so that by clicking on the button, the screen changes to the screen/task/chart corresponding to the button clicked. Note that the screen 288 also lists on the bottom the percentage of the tasks/charts that have the status of “complete” and the number of tasks/charts that need to be performed.

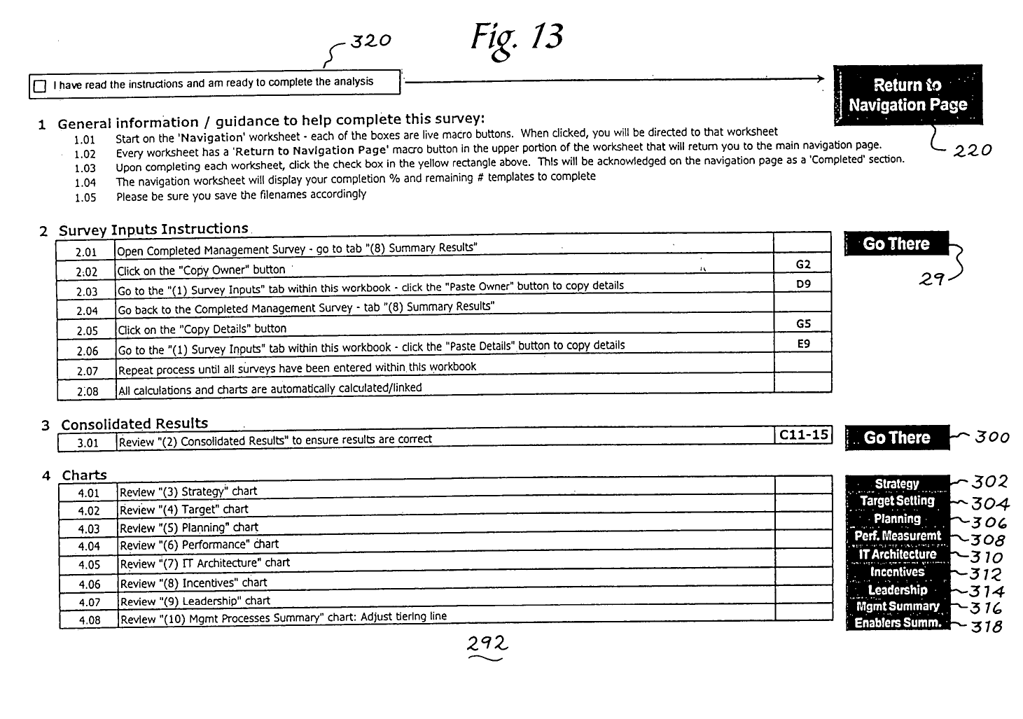

Enabling the “Go to Instructions” button 290 of the status screen 288 results in the instructions screen 292 of FIG. 13 being displayed on the visual display 210. The screen 292 provides instructions for completing various tasks/charts associated with the consolidation tool. For example, the screen 292 includes general information and guidance on how to complete the surveys to be given to the client.

In addition, the screen 292 provides instructions (see instructions 2.01-2.08) on how to transfer data from multiple surveys taken at different time frames into the consolidation table 294 shown in FIGS. 14A-B. The screen 292 has a “Go There” button 296 that allows the user to go to the consolidation table 294 by clicking on the button.

Note that the instructions screen 292 includes a button 220 to return to the navigation screen 226. The screen 292 also allows access to a consolidated results screen 298 via “Go There” button 300 and to seven charts (via buttons 302, 304, 306, 308, 310, 312 and 314) that correspond to the consolidate results for the seven surveys accessible from the navigation screen 226 of the enterprise performance management system 200. Management summary and enablers summary charts are also available via buttons 316 and 318, respectively. The various screens and charts are discussed below.

Once all of the instructions have been reviewed by the user, the user clicks on the completion box 320 as shown in FIG. 13. Clicking on box 320 results in the “Instructions” task to have a status of “Complete” registered on status screen 292.

Once the user has completed the instruction screen 292, he or she is prepared to transfer multiple surveys conducted for the same client onto a single chart, such as the one shown on screen 294 (FIGS. 14A-B). The transfer involves going back and forth between the survey information (via button 220) and the chart of screen 294 while following the instructions of screen 292 (via button 222). Transfer is accomplished by clicking on button 286. Once the transfer is complete, the consolidation tool automatically provides a summary of the results for the multiple surveys. An example of this is shown in FIG. 15, wherein three surveys covering the strategic plan and target setting areas of inquiry are entered and displayed on a single advice screen. Besides the surveys, the advice screen 294 also shows a summary of calculated results that includes the average value, standard deviation, low and high values for the current state or capability rating. The screen 294 also shows the calculated average value, standard deviation, low and high values for the weightings or value ratings for the various areas of inquiry. The average values of the average, low and high values can also be calculated and displayed on screen 294.

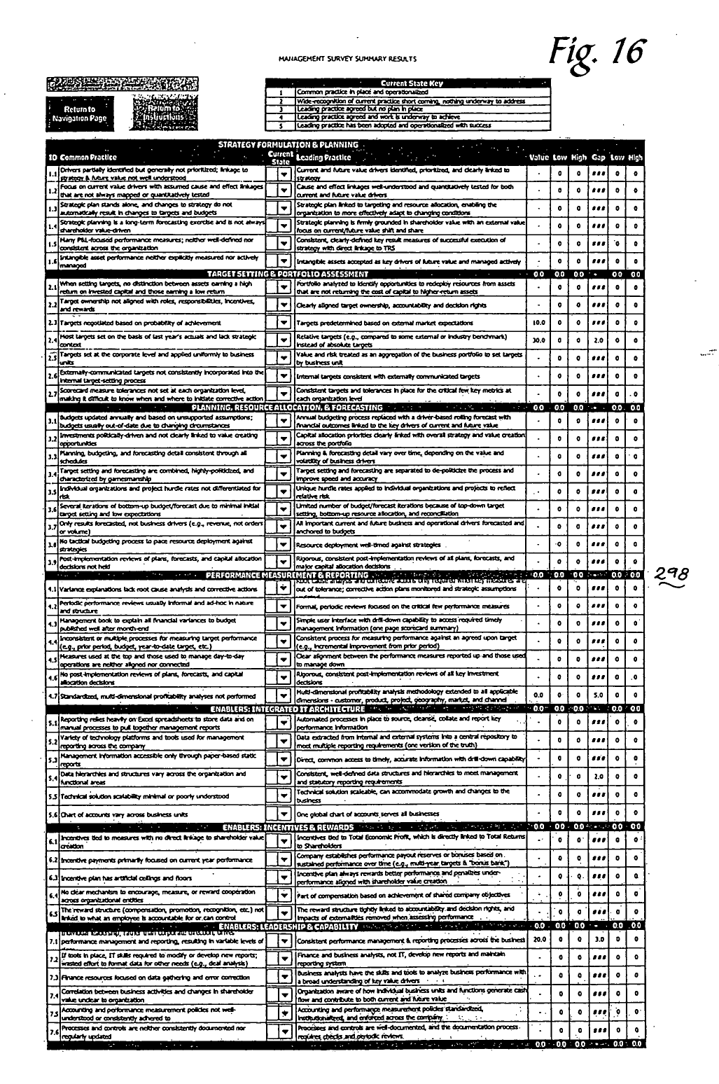

The consolidated results for the multiple surveys can be viewed on the consolidation advice screen 298 of FIG. 16 by clicking on button 300 of the status screen 288 of FIG. 12. In this view, only the average, high and low values for the current state and the gap, the difference between a current value and the leading practice value of 5, are shown.

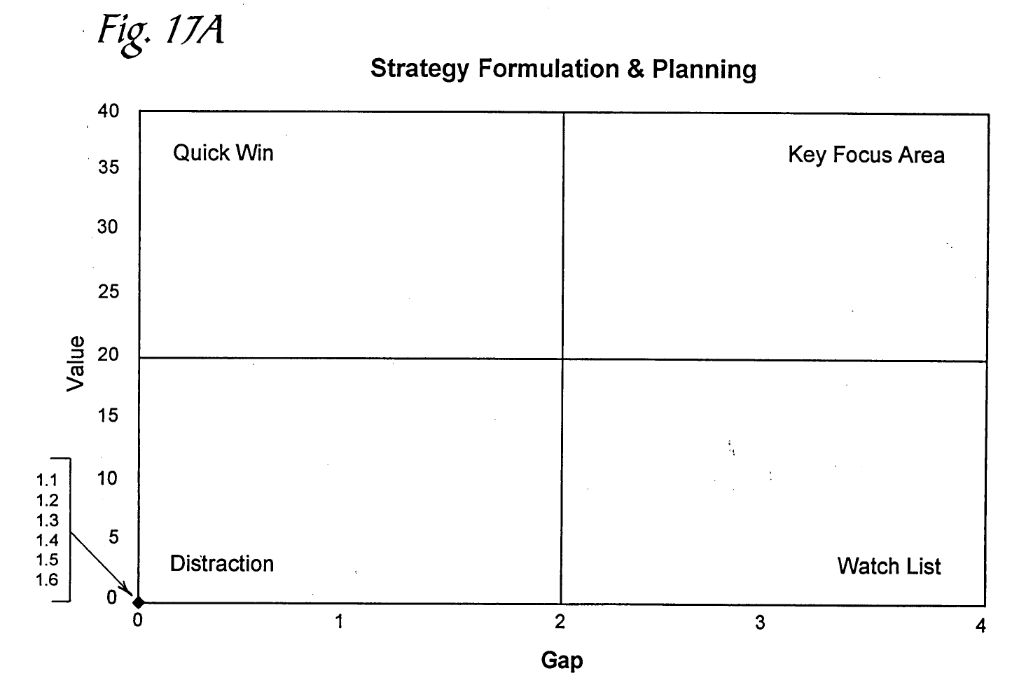

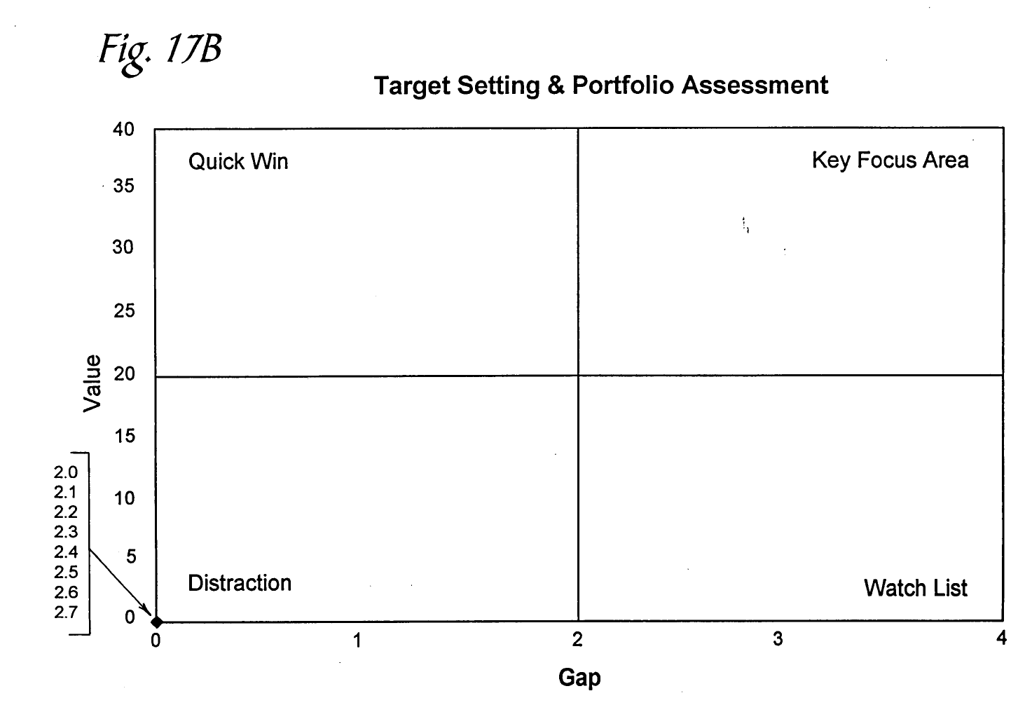

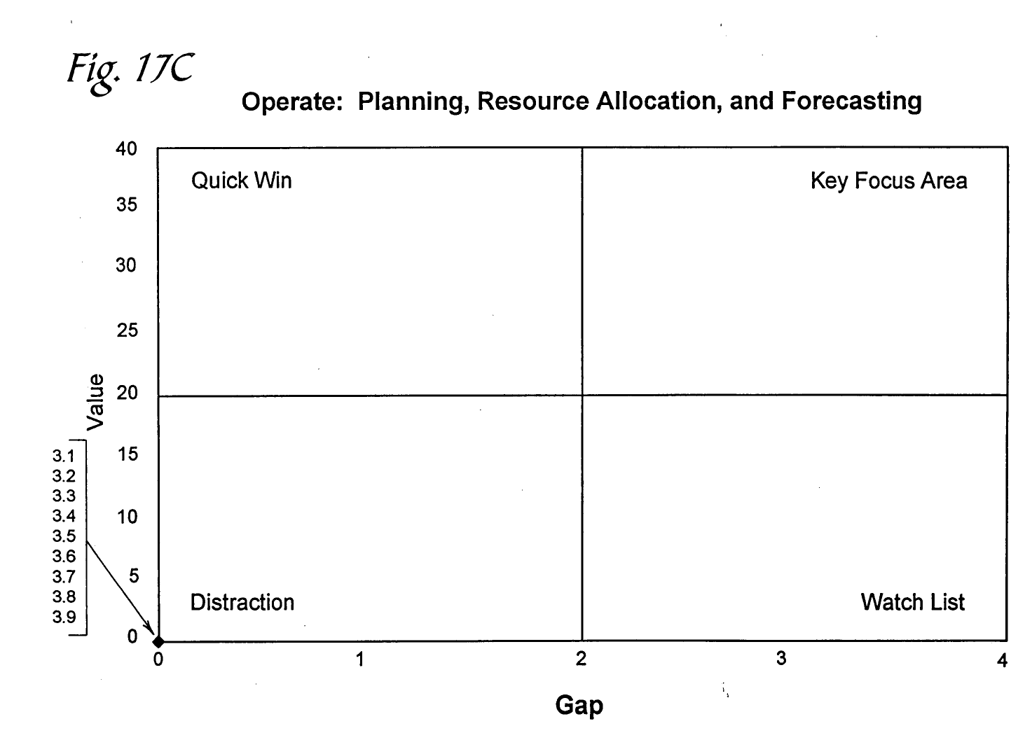

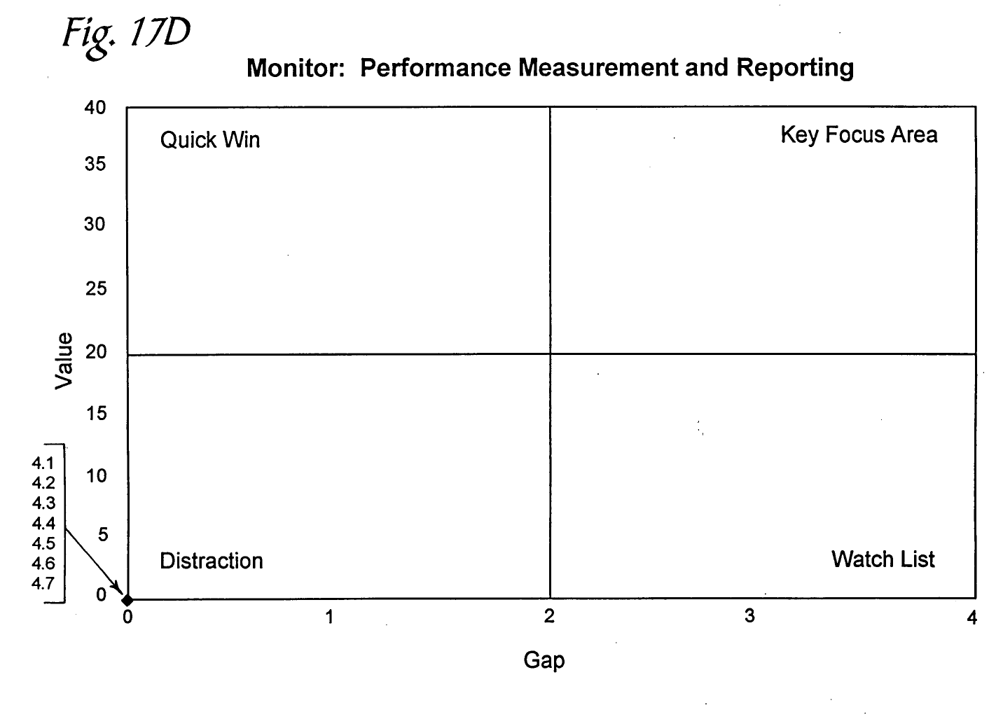

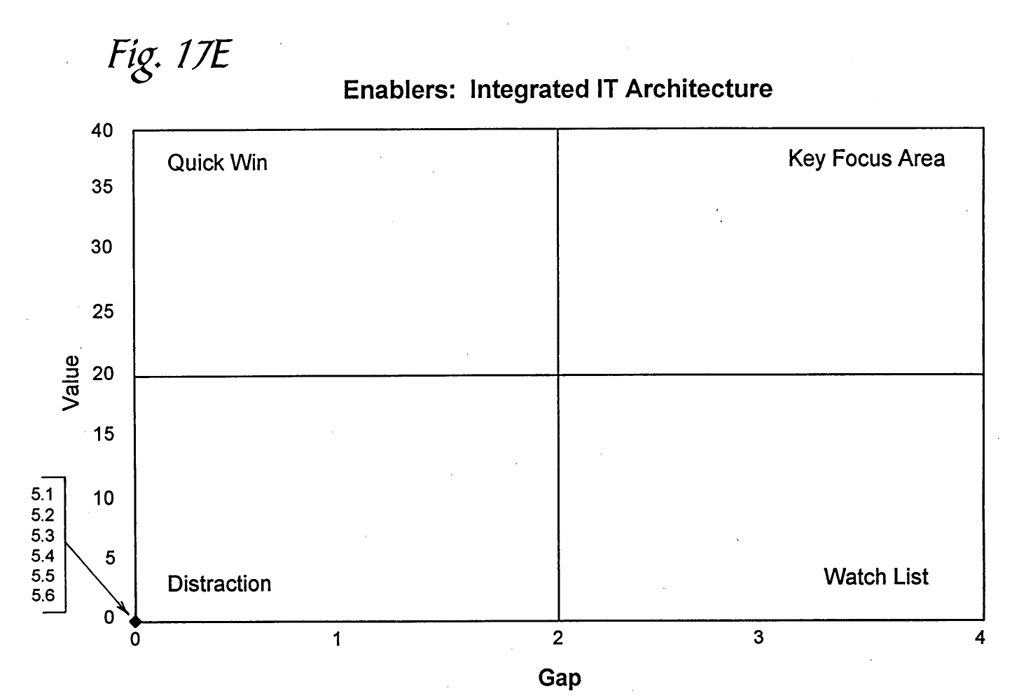

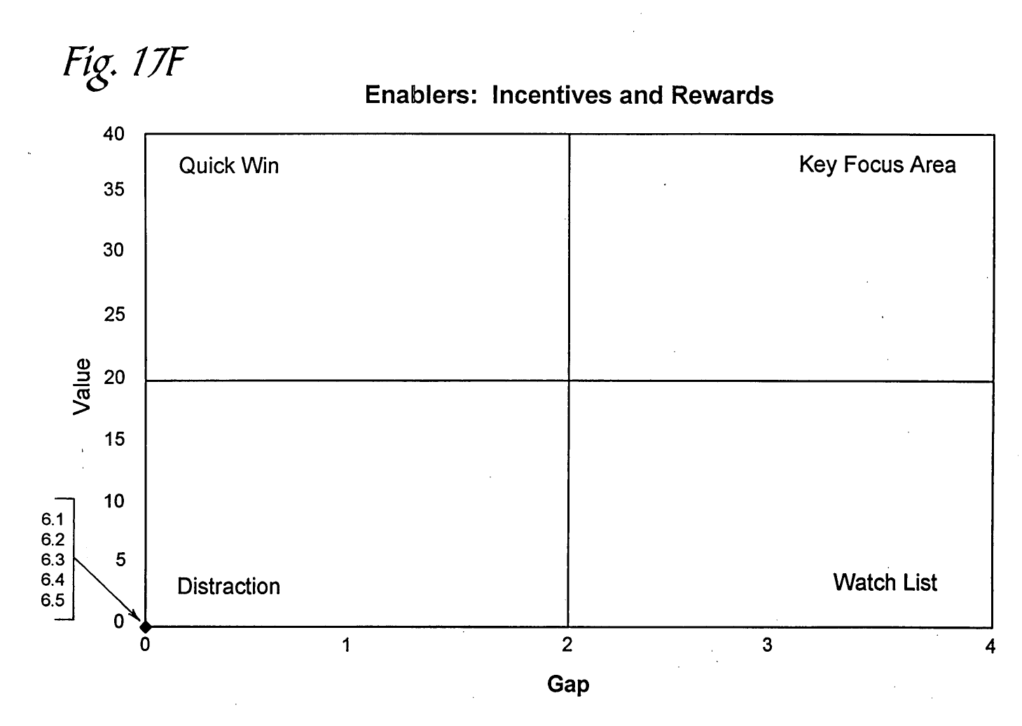

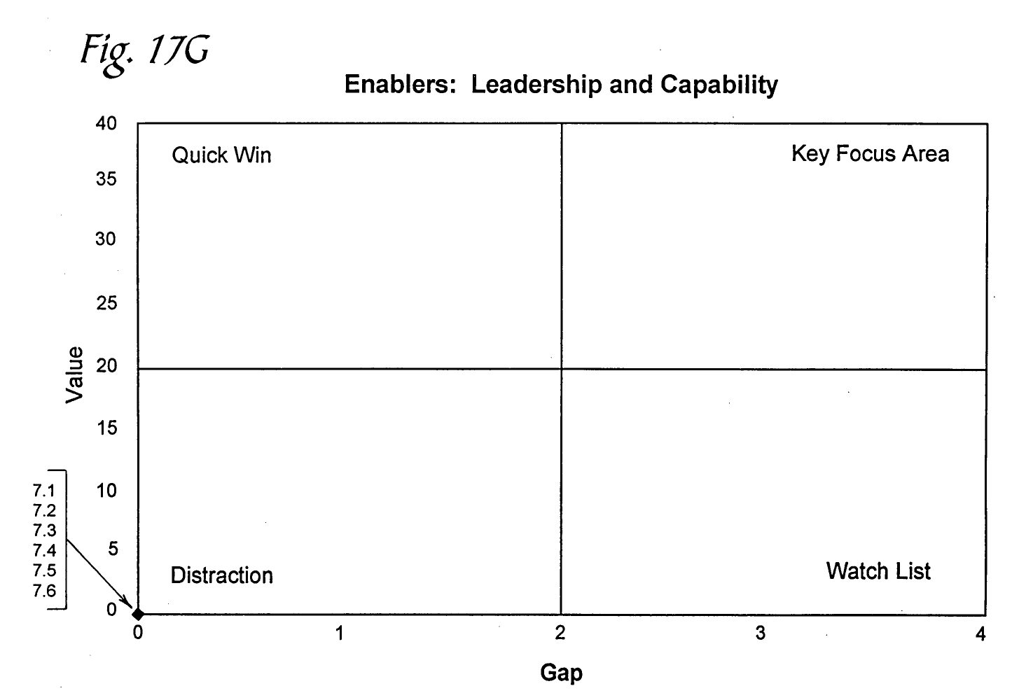

With the data calculated and displayed on the consolidation screen 298, seven charts are automatically generated as shown in FIGS. 17A-G. The charts correspond to the seven surveys described previously and are accessed by clicking on either the buttons 322, 324, 326, 328, 330, 332, 334 of screen 288 of FIG. 12 or buttons 302, 304, 306, 308, 310, 312, 314 of screen 292 of FIG. 13. FIG. 17A is representative of the other charts of FIGS. 17B-G and plots the value versus the gap value for each of the questions of the strategy formulation & planning survey. When the weighted value for a particular question is greater than 20 and the gap value is less than 2, then the client's association with the question is considered to be a “Quick Win” meaning that quickly focusing on this particular performance management area can quickly be translated into tangible results. When the weighted value for a particular question is greater than 20 and the gap value is greater than 2, then the client's association with the question is considered to be a “Key Focus Area” meaning that focusing time and effort on this particular performance management area will yield the highest results/impact for the company.. When the weighted value for a particular question is less than 20 and the gap value is less than 2, then the client's association with the question is considered to be “Distraction” meaning the time and effort needed to solve the performance management issues will not result in a material impact to the company's performance. When the weighted value for a particular question is less than 20 and the gap value is greater than 2, then the client's association with the question is considered to be on the “Watch List” meaning these issues should be reviewed over time to determine if solving these issues will have a material impact on the company's performance.

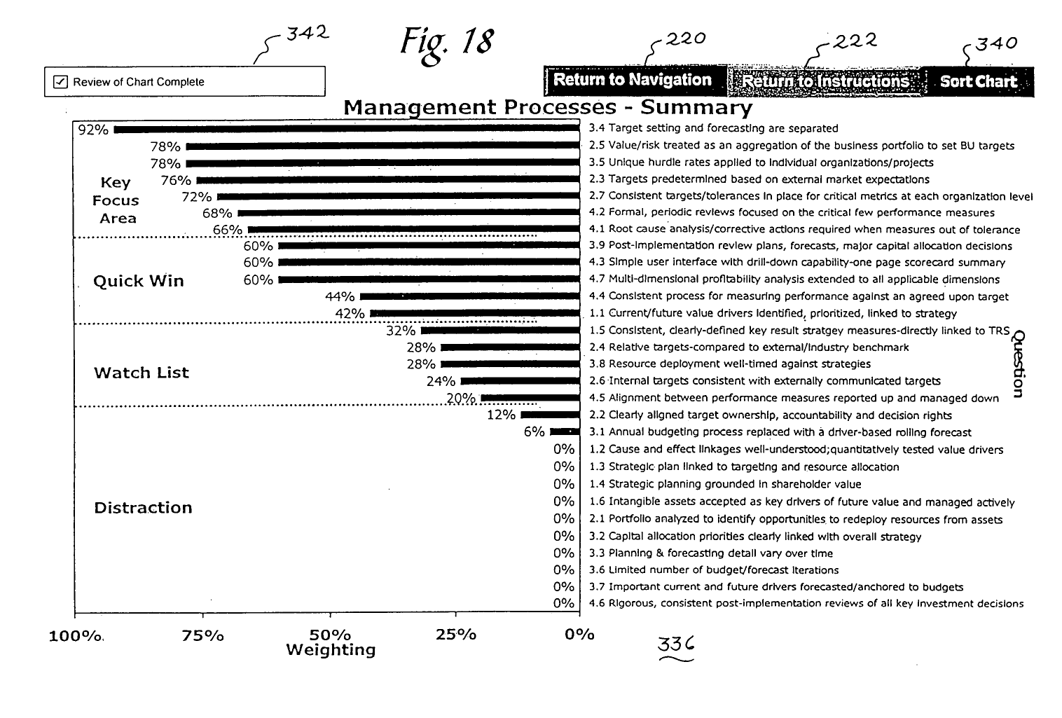

The results of the charts of FIGS. 17A-D can be recast in the management processes summary chart 336 shown by FIG. 18. The survey questions are listed on the right side and the weightings with their associated labels are listed on the left side. The chart 336 is displayed as an advice screen on the visual display 210 by clicking on the button 338 of screen 288 of FIG. 12 or button 316 of screen 292 of FIG. 13.

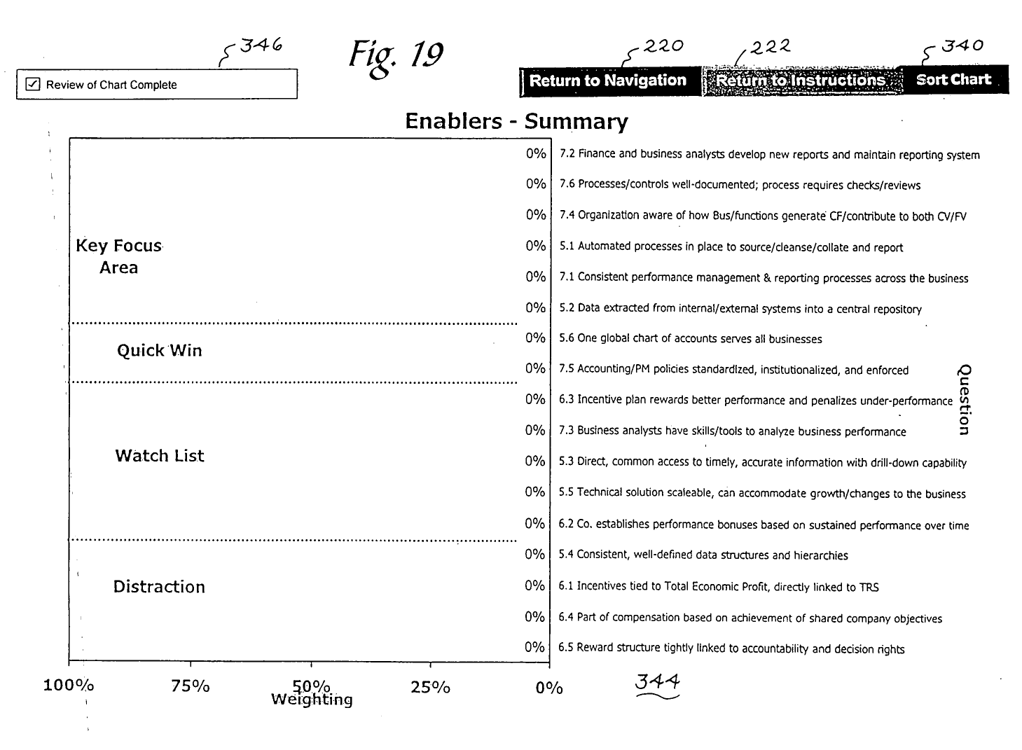

At this stage, the user can activate either the “Return to Navigation Page” button 220 shown in FIG. 18 to return to screen 226 of FIG. 7, the “Return to Instructions” button 222 shown in FIG. 18 to return to screen 292 of FIG. 13. Actuating the “Sort Chart” button 340 shown in FIG. 18 sorts the data independently on FIGS. 18 and 19. The sort button will automatically sort the aggregated scores in an ascending order, providing the user the ability to quickly determine which performance management sections should be addressed.

Once the chart 336 has been reviewed by the user, the user clicks on the completion box 342 as shown in FIG. 18. Clicking on box 342 results in the “Management Process Summary Chart” task to have a status of “Complete” registered on status screen 288 of FIG. 12.

In a similar manner, the results of the charts of FIGS. 17E-G can be recast in the enablers summary chart 344 shown in FIG. 19. The survey questions are listed on the right side and the weightings with their associated labels are listed on the left side. The chart 344 is displayed as an advice screen on the visual display 210 by clicking on the button 346 of screen 288 of FIG. 12 or button 318 of screen 292 of FIG. 13.

At this stage, the user can activate either “Return to Navigation Page” button 220, “Return to Instructions” button 222 or the “Sort Chart” button 338 which operate in the same manner as described previously with respect to the corresponding buttons of the chart 336 of FIG. 18.

Once the chart 344 has been reviewed by the user, the user clicks on the completion box 346 as shown in FIG. 19. Clicking on box 346 results in the “Enablers Summary Chart” task to have a status of “Complete” registered on status screen 288 of FIG. 12.

The answers given by a client during the above described mid-level inquiry 104 are designed to aid the system 200 in providing advice to the client. The process of providing advice may involve performing the process of listening or recording the client's answers to the various diagnostic questions. Based on those answers the user enters a current state value for each area of interest on the appropriate advice screens of FIGS. 10A-G.

Upon entering the current state values, the user will have the advice screen before him or her and will be able to simultaneously view the client's current state and the common practice and leading practice benchmarks associated with the question corresponding to the answer. The simultaneous display of the current state and the benchmarks and their side-by-side format on the advice screens of FIGS. 10A-G allows the advice screens to function as a comparator from which advice is implicitly generated. For example, if the current state on the advice screen is a 5, then the enterprise performance management system 200, via one of the advice screens FIGS. 10A-G, implicitly generates the advice that the client is deemed a leading practitioner in this area of inquiry and should continue its current practice. If the current state shown on the advice screen is below 5 then the system 200, via the advice screen, provides a side-by-side comparison of the current state and the common and leading practices. In either case, the advice screen acts as a visual comparator that visually illustrates/determine the differences between the current state and the common and leading practices. Such a comparison allows the advice screen to generate implicit advice regarding the status of the client and what steps need to be taken by the client in order to be considered to be a leading practitioner in a particular area. For example, if the current status is 4 (i.e., the client is performing at least the common practice and agrees to practice the leading practice and work is currently underway to implement the leading practice) then the advice screen implicitly advises the user that: 1) the client is deemed to be at least practicing what is common among other organizations and 2) the client needs to complete its work for implementing the leading practice. The advice screens of FIGS. 10A-G provide the additional advice to the client as to which ones of the areas of inquiry need to be addressed soonest by comparing the weighting values given to the areas of inquiry. For example, an area of inquiry having a current value of 1 and a weighting of 10 need not be addressed prior to an area of inquiry having a current value of 3 and a weighting of 75. Thus, the advice screens implicitly provide prioritization advice.

The advice screens can also provide implicit advice when compared with one another via advice screen 278. For example, suppose the advice screen for the “Strategy Formulation & Planning” category has a majority of current state values that are near the common value of 1 while the advice screen for the “Target Setting & Portfolio Assessment” category has a majority of current state values that are near the leading practice value of 5. In this case, a comparison of the two screens would implicitly advise the user that a client with limited resources should concentrate those resources in the “Strategy Formulation & Planning” area rather than “Target Setting & Portfolio Assessment.”

Another case where advice screens provide advice for the client is when the advice screens 294 and 298 of FIGS. 15 and 16 are considered. Each screen provides the current, low and high values of the capability rating and/or the value rating. Such values help the user to see a trend as to whether or not the client is making progress in achieving leading practice status regarding an area of interest.

The 2×2 matrices of FIGS. 17A-G and the charts of FIGS. 18-19 also provide the user with advice for an area of interest depending on which one of the four quadrants the area of interest falls. For a “Quick Win” case, the advice would be to quickly focus on this particular performance management area to have a quick impact on the company's performance. For a “Key Focus Area” case, the advice would be that focusing time and effort on this particular performance management area will yield the highest results/impact for the company. For a “Distraction” case, the advice would be the time and effort needed to solve the performance management issues will not result in a material impact to the company's performance. For a “Watch List” case, the advice would be these issues should be reviewed over time to determine if solving these issues will have a material impact on the company's performance.

Based on the process described above, it is evident that the financial diagnostic system 100 provides a format on the advice screens of FIGS. 8A-B that by itself implicitly provides advice to the client based on the contents of one or more of the advice screens.

In summary, based on the scores and comparisons, the system 200 via the advice screens can identify strengths and weaknesses in the organization. Furthermore, the advice screens implicitly provide suggestions on how the organization can improve its scores. This advice is based on the fact that the advice screen 1) always shows the ideal or leading practice that an organization strives to achieve, 2) simultaneously shows the real condition of the client via its answer, 3) simultaneously shows the common practice in the industry and 4) provides a side-by-side visual comparison of the ideal or leading practice with the answer that implicitly provides advice on how to make corrections so that the leading practice can be achieved. A common follow on discussion of the interviewer with the client would be to summarize the results of the diagnostic, and then discuss those leading practices that are not being followed as a way to identify improvement opportunities. The user then can offer services that can cure the deficiencies or that perform the deep-level inquiry 106 so as to dig deeper into the causes of a problem.

Note that there a number of possible ways of implementing the system 200 describe above. For example, the processor 202, input device 208 and display 210 can be taken in the form of a laptop computer to the interview by the interviewer. At the interview, the interviewer asks the various questions and enters them as described previously. The interviewer can evaluate the answers directly on the laptop computer or the results can be sent offsite to an offsite central computer 214 via the internet 213 where they can be evaluated.

The invention may be embodied in other forms than those specifically disclosed herein without departing from its spirit or essential characteristics. The described embodiments are to be considered in all respects only as illustrative and not restrictive, and the scope of the invention is commensurate with the appended claims rather than the foregoing description.

I claim:

1. An enterprise performance management system comprising:
a processor;
a visual display electrically connected to said processor, wherein said processor prepares an advice screen to be shown on said visual display, said advice screen displaying:
1) a first benchmark that represents a predetermined level of practice corresponding to an area of inquiry;
2) a second benchmark that represents a second predetermined level of practice corresponding to said area of inquiry;
3) a current state value that is representative of an entity's current level of practice regarding said area of inquiry; and
4) a weighting factor representative of the importance of said area of inquiry, wherein said first benchmark, said second benchmark, said current state and said weighting factor are displayed simultaneously so that advice on how to prioritize and accomplish achievement of a desired level of practice is rendered by such simultaneous display.

2. The enterprise performance management system of claim 1, wherein said predetermined level corresponds to a leading practice and said leading practice is said desired level of practice.

3. The enterprise performance management system of claim 1, wherein said second benchmark represents a common practice corresponding to said area of inquiry.

4. The enterprise performance management system of claim 2, wherein said second benchmark represents a common practice corresponding to said area of inquiry.

5. An enterprise performance management system comprising:
a processor;
a visual display electrically connected to said processor, wherein said processor prepares an advice screen to be shown on said visual display, said advice screen displaying:
1) a first state value that is representative of an entity's level of practice regarding an area of inquiry during a first time frame; and
2) a second state value that is representative of an entity's level of practice regarding said area of inquiry at a second time frame different than said first time frame, wherein said first state value and said second state value are displayed simultaneously so that advice on how to achieve a desired level of practice is rendered by such simultaneous display.

6. The enterprise performance management system of claim 5, wherein said advice screen displays a weighting factor simultaneously with said first state value and said second value, wherein said weighting factor is representative of the importance of said area of inquiry and said advice is based in part on said weighting factor.

7. A method of providing advice on how to achieve a desired level of practice, comprising:
having a client provide an answer regarding a financial related question regarding an area of interest;
determining a current state level of said client based on said answer;
preparing and displaying an advice report by simultaneously displaying said current state level, a first benchmark that represents a predetermined level of practice corresponding to said area of interest and a second benchmark that represents a second predetermined level of practice corresponding to said area of interest, wherein advice on how to achieve a desired level of practice is rendered by such simultaneous displaying; and
providing advice to said client based on said advice report so that said client achieves said desired level of practice.

8. The method of claim 7, wherein said advice report provides a visual comparison of said current state level and said first and second benchmarks and said providing advice is based on said visual comparison.

9. The method of claim 7, wherein said first benchmark and said desired level of practice are the same and are a leading level of practice.

10. The method of claim 7, wherein said first benchmark is a common level of practice regarding said area of interest.

11. The method of claim 7, wherein said first benchmark is a leading level of practice regarding said area of interest.

12. The method of claim 11, wherein said second benchmark is a common level of practice regarding said area of interest.

13. The method of claim 7, wherein said preparing and displaying an advice report comprises simultaneously displaying a weighting factor representative of the importance of said area of inquiry, wherein said first benchmark, said second benchmark, said current state and said weighting factor are displayed simultaneously so that advice on how to prioritize and accomplish achievement of a desired level of practice is rendered by such simultaneous display.
